(19) United States
(12) Patent Application Publication
(10) Pub. No.: US 2011/0088616 A1
(43) Pub. Date: Apr. 21, 2011

(54) PAINTING BOOTH WITH POWDERED PAINT SUPPRESSION SYSTEM

(76) Inventor: Achille Borzone, Cernusco ul Naviglio (IT)

(21) Appl. No.: 12/736,571

(22) PCT Filed: May 20, 2009
(86) PCT No.: PCT/IB2009/005699

§ 371 Date: Jan. 3, 2011

(30) Foreign Application Priority Data
May 23, 2008 (IT) MI2008A000963

(51) Int. Cl. B05C 19/06

(52) U.S. Cl. 118/308

(57) ABSTRACT

A painting booth (10) with powdered paint comprises a painting chamber (11) in which the powdered paint is sprayed and an underlying service chamber (30). The painting chamber (11) has a grated floor (15) for sucking in the air in it and that leads to paint filtering and suppression groups (17). The groups (17) comprise a first inlet area (22) with cyclone air flow to cause powder to fall out from the flow into an underlying collection hopper (23) followed by filters (24, 124) that are crossed in succession by the air flow.

The present invention refers to a painting booth of the type equipped with a suppression system of the powdered paint in the process air coming out from the booth.

In the prior art painting booths using powdered paint are known that are equipped with a suppression system that comprises air evacuation grates that are arranged in the floor of the booth and that lead to filters for holding powdered paint arranged immediately under the vertical of the floor of the booth. The air that is sucked in through the grates in the floor thus crosses the filters directly, holding the excess sprayed powdered paint in the booth.

Such a known arrangement of the filters allows the space immediately below the floor of the booth to be fully exploited, but the filters are hard to reach for maintenance and at the same time they are not very well protected from the entry of objects through the grates in the booth. Moreover, the filters quickly become clogged, starting up the counter-current compressed air washing system due to the fact that all of the excess powdered paint reaches the filters; the cleaning system also reverberates noise towards the booth.

In addition, the stress of the filtering material caused by the repeated powdered paint collection and counter-washing cycles over time leads to the need to replace the filters themselves.

The general purpose of the present invention is to obviate the aforementioned drawbacks by providing a painting booth with a powdered paint recovery system that is more efficient, is easier to maintain and that can contribute to reducing the noise of the unit.

In view of such a purpose, it has been thought of to make, according to the invention, a painting booth using powdered paint, comprising a painting chamber in which the powdered paint is sprayed and an underlying service chamber, the painting chamber having a grated floor for sucking the air in it that leads to powdered paint filtering and suppression groups, characterized in that the groups comprise a first inlet area with cyclone air flow to cause powder to fall out from the flow into an underlying collection hopper, followed by filters that are crossed in succession by the air flow.

In order to make the explanation of the innovative principles of the present invention and its advantages compared to the prior art clearer, hereafter, with the help of the attached drawings, we shall describe a possible example embodiment applying such principles. In the drawings:

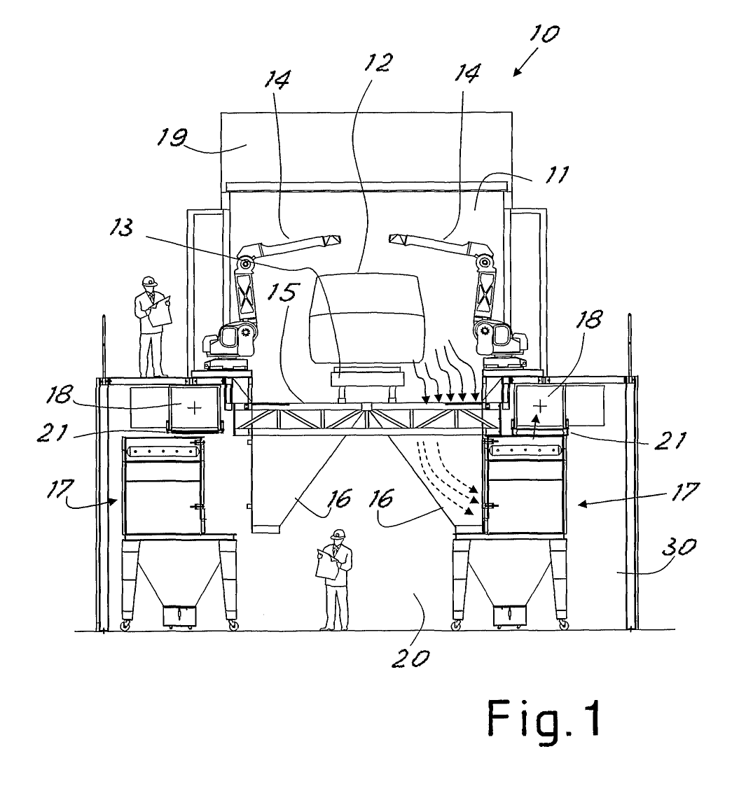

FIG. 1 represents a schematic section view of a painting booth according to the invention;

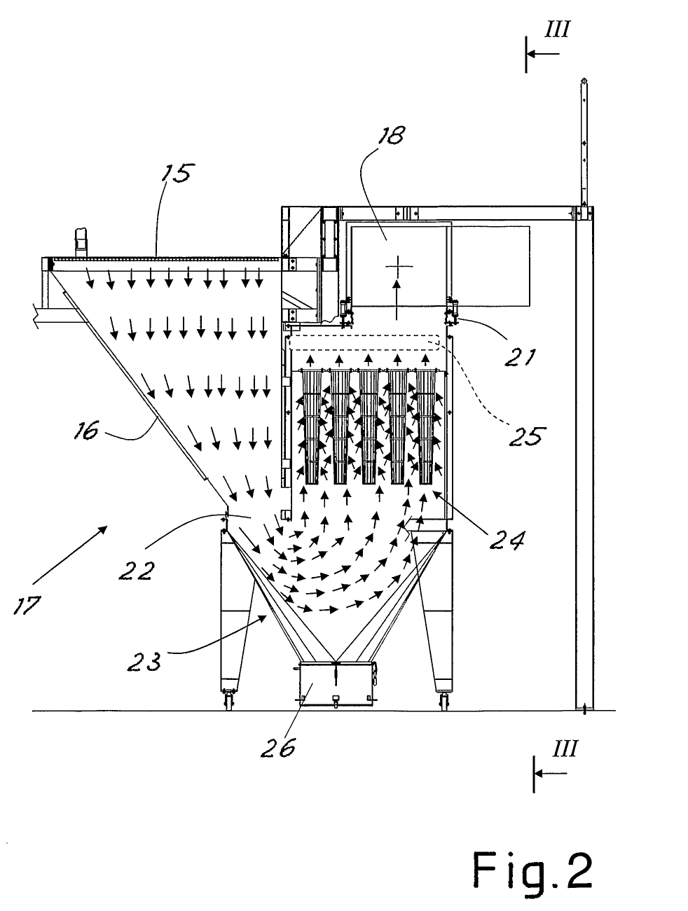

FIG. 2 represents an enlarged section view of a powdered paint suppression area of the booth of FIG. 1;

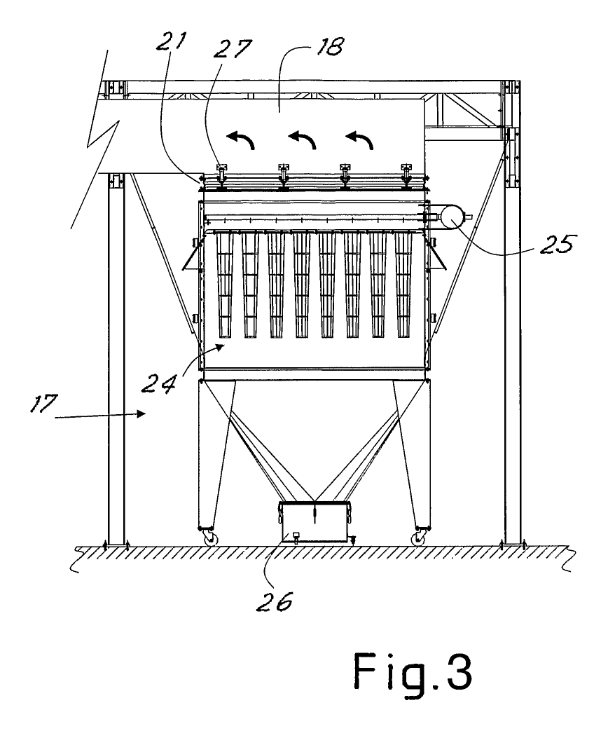

FIG. 3 represents a partially sectioned view of the suppression area taken along the line III-III of FIG. 2;

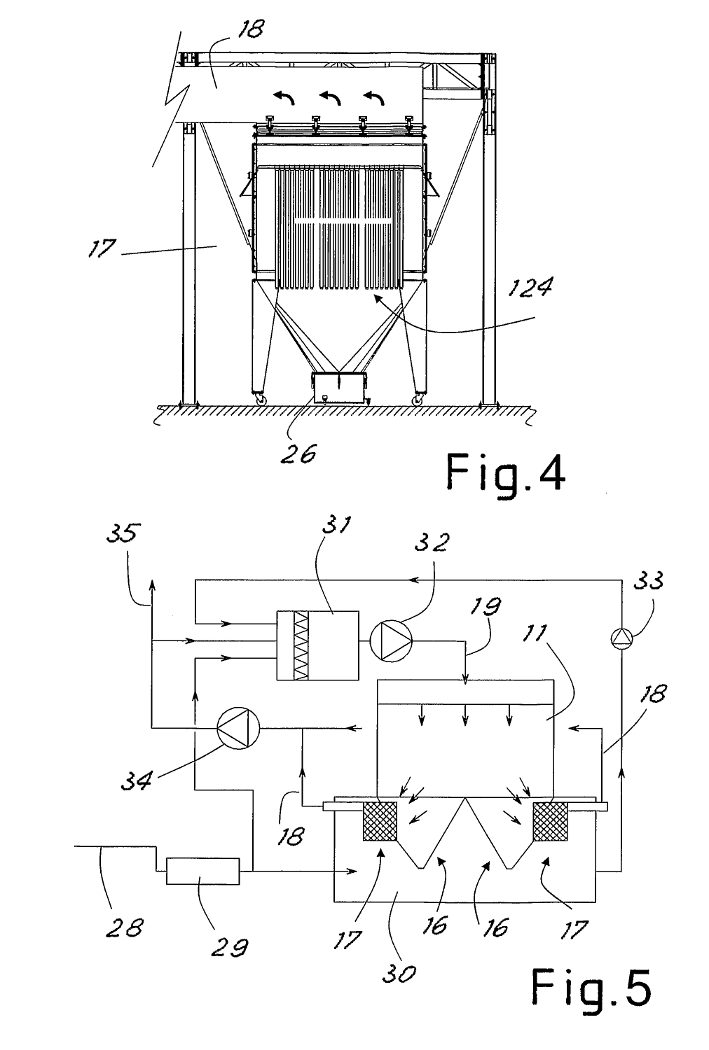

FIG. 4 represents a view similar to the one of FIG. 3 but showing a variant embodiment with a different type of filter;

FIG. 5 represents a schematic view of the air circulation and powdered paint suppression unit of the booth according to the invention.

With reference to the figures, FIG. 1 shows a powder painting booth, generically indicated with 10, made according to the invention. The booth comprises a painting chamber 11 wherein the objects 12 to be painted (for example the bodywork of vehicles) are taken, advantageously through a known rail transportation system 13. In the chamber there are also known paint spraying devices 14, advantageously made or comprising suitable known robotized arms.

The floor 15 of the chamber 11 is formed from grates through which the air of the chamber is sucked to evacuate the excess powder sprayed. In the ceiling of the chamber there are corresponding air inlets, for example made with a suitable grated ceiling and an air inlet and transportation duct 19. The grated floor 15 communicates at the bottom with respective inclined ducts 16 that convey the air to the powder filtering and extraction, groups 17 that are advantageously arranged under the floor and at the side. The groups are also advantageously arranged substantially outside of the vertical of the floor.

From the filtering groups the air passes to cleaned air evacuation ducts 18, which are advantageously arranged alongside the floor of the chamber and substantially at the same level as the floor.

A large access space 20 is thus provided under the floor of the painting chamber. Moreover, the filtering and extraction groups can be easily moved at the side for maintenance, as shown for the left group in FIG. 1. The entire group can be supported through suitable wheels for easier movement. Where needed, the entire filtering group can be removed and replaced by another one quickly and easily.

The entire area 20 and the groups 17 can in turn be contained in a service chamber 30.

The coupling between inclined fitting 16 and air inlet into the group 17 can take place in the direction of lateral sliding of the group, whereas the coupling between air outlet from the group 17 and the evacuation duct 18 can advantageously be made through an extensible bellows coupling element 21, possibly motorized by suitable lifting actuators, as shall be made clearer hereafter.

The duct 16 can be made open at the side and it is the same side wall of the group 17 that closes it on the side. This facilitates access and cleaning.

FIG. 2 shows the section of one of the groups 17 in greater detail.

The group comprises a first inlet area 22 that makes an air flow with “cyclone” separation, with the heavier particles leaving the air flow and falling into an underlying hopper 23 before reaching the filters 24.

In the embodiment shown, the air flow conveyed by the inclined duct 16 (with generically triangular section to narrow from the upper grating 15 to the inlet of the group 17) enters from above into the inlet area of the cyclone to then curve upwards and enter from below into the group of filters 24. Advantageously, the filters are arranged vertically above the hopper, so as to promote cleaning through injection of an air flow in countercurrent injected upon command through a pressurized duct 25 (FIG. 3) during a cleaning cycle. The powder removed thus falls back into the hopper 23 below.

The hopper can have a collection tank 26 for the powders, which is easy to remove. Automatic systems (mechanical, pneumatic, etc.) for removing powder from the hopper can also be conceived.

In the solution of FIG. 2, the filters are in cartridge form, with each filter that is crossed by the air towards the inside of the cartridge to then come out from its upper end being open towards the evacuation duct 18. As can be seen in FIG. 3, the cleaning duct 25 can have nozzles for emitting air jets coaxial to each filter, so as to optimize the amount of air with respect to the cleaning effect of the filter. The powder freed from the wall of the filter easily falls back into the underlying hopper 23. Advantageously, the cartridge filters are conical in shape, with the base of the cone facing towards the outlet. The conicity is made so that the rising speed in the various sections of the filter box is constant, allowing the powdered paint to fall down towards the recovery tank at the foot of the hopper. Alternatively, the filters can also be arranged horizontally, although such an arrangement may be less efficient for cleaning.

In FIG. 3 it is possible to see in greater detail the connection bellows 21, with actuators 27 that control the extension of the bellows when the unit is in use and the retraction of the bellows when it is necessary to move the filtering group from the operative position to the side maintenance position. Advantageously, as can be seen in FIG. 1, the bellows retracts by raising its lower edge from the outlet mouth of the filtering group.

As shown schematically in FIG. 4, instead of the cartridge filters sintered plate filters 124 can also be advantageously used. The rest of the structure can remain substantially the same, optimizing the costs of the unit.

FIG. 5 shows a scheme of the booth unit according to the invention. The air is sucked in from the outside through an inlet 28 and a first filtering and conditioning stage 29. Advantageously, a fraction of air is injected into the lower chamber 30 that contains the filters to keep it in suitable ambient conditions (temperature and humidity). Another fraction of air is sent to a mixing group or box 31 at the outlet of which a fan 32 takes the air to be sent to the inlet of the chamber 11 through the duct 19 and the relative distribution plenum.

The mixing group also advantageously has air sent to it that has been recovered from the lower chamber 30, sucked in by a fan 33, as well as part of the air coming out from the powder filtering and extraction groups and sucked in by a fan 34. The air sucked in downstream of the filtering and extraction groups 17 is also partly sent to an expulsion chimney 35.

The volume of air expelled from the chimney 35 (for example 10000 m³/h) is substantially equal to the volume of air sucked in at the inlet 28. Thanks to the recirculation of air through the painting chamber 11 and, possibly, through the service chamber 30 below, the volume of clean air that circulates in the painting chamber can be considerably greater than the amount sucked in from the outside. For example, the air flow through the chamber 11 can be 52000 m³/h with, for example, 10000 m³/h taken from the outside through the CTA 29, a part sent to the service chamber 30 and the remaining part directly to the mixing box, and the rest recycled by the outlet of the groups 17.

At this point it is clear how the preset purposes are accomplished. The cyclone air flow allows high efficiency and reduction of bulk and maintenance time. The filtering elements are in a more protected position and the filter cleaning system does not reverberate the noise towards the painting booth thanks to the “indirect” flow. The boxes can also be easily sound-proofed. There is also the possibility of quick and easy maintenance by unhooking the boxes and moving them. Moreover, the filters stay positioned above the hoppers. Sintered plate or cartridge-type filters can be used without distinction. In the case of cartridge-type filters, the use of conical filters improves the distribution of the air flows going by with the powdered paint falling towards the recovery tank. In addition to better powdered paint suppression, the filters are under less stress and clog up less frequently, since there is a first suppression thanks to the cyclone effect and the filters are not subject to filtering the totality of the powdered paint caused by overspray and sucked through the floor of the painting booth.

Of course, the above description of an embodiment applying the innovative principles of the present invention is given as an example of such innovative principles and therefore should not be taken to limit the scope of protection claimed here. For example, as can easily be imagined by the man skilled in the art, proportions, sizes and exact shape and arrangement of parts of the unit can vary according to the specific requirements. The central free space in the service chamber can be used to receive other devices of the unit.

1. Painting booth with powdered paint, comprising a painting chamber in which the powdered paint is sprayed and an underlying service chamber, the painting chamber having a grated floor for sucking in the air in it that leads to powdered paint filtering and suppression groups, wherein the groups comprise a first inlet area with cyclone air flow to cause powder to fall out from the flow into an underlying collection hopper followed by filters that are crossed in succession by the air flow, the filtering groups being arranged below floor level and at the side and there are inclined ducts that connect the inlet of the groups with the grated suction floor, and the filtering and suppression group is laterally mobile to move it away from the operative position connected to the inclined duct for connection with the suction intakes and to an upper duct for evacuating the air coming out from the group.

2. (canceled)

3. Booth according to claim 1, wherein the filters are arranged above the hopper.

4. Booth according to claim 3, wherein the filters are arranged vertically.

5. Booth according to claim 4, wherein the filters are in cartridge or sintered plate form.

6. Booth according to claim 5, wherein the cartridge filters are conical with base facing upwards and for the outlet of the filtered air flow.

7. Booth according to claim 4, wherein above the filters there are countercurrent blowing means to clean them and make the powdered paint fall from the filter to the hopper.

8. (canceled)

9. Booth according to claim 1, wherein the upper duct comprises a bellows connection that is retractable to move away upon command from the group and disconnect from its outlet.

10. Booth according to claim 1, wherein air taken from outside is entered into the service chamber.

11. Booth according to claim 1, wherein the air coming out from the groups is sent partially to an evacuation chimney and partially to an air recirculation that is entered back into the painting chamber.

12. Booth according to claim 11, wherein air coming out from the service chamber and/or air taken from the outside is also entered into the air recirculation.

13. Booth according to claim 11, wherein the air is entered back into the painting chamber through a main mixing box.
